(19) United States
(12) Patent Application Publication
(10) Pub. No.: US 2015/0278582 A1
(43) Pub. Date: Oct. 1, 2015

(54) Image Processor Comprising Face Recognition System with Face Recognition Based on Two-Dimensional Grid Transform

(71) Applicant: Avago Technologies General IP (Singapore) Pte. Ltd, Singapore (SG)

(72) Inventors: Alexander Alexandrovich Petyushko, Bryansk (RU); Denis Vladimirovich Zaytsev, Dzerzhinsky (RU); Pavel Aleksandrovich Aliseitchik, Moscow (RU); Denis Vladimirovich Parkhomenko, Mytyschy (RU); Alexander Borisovich Kholodenko, Moscow (RU)

(21) Appl. No.: 14/668,550

(22) Filed: Mar. 25, 2015

(30) Foreign Application Priority Data
Mar. 27, 2014 (RU) 2014111792

(51) Int. Cl. G06K 9/00; G06T 5/20; G06T 7/00; G06T 5/00

(52) U.S. Cl. CPC G06K 9/00261; G06K 9/00248; G06T 5/002; G06T 5/20; G06T 7/0061; G06T 2207/10028; G06T 2207/20024; G06T 2207/20048; G06T 2207/20182; G06T 2207/30201

(57) ABSTRACT

An image processing system comprises an image processor having image processing circuitry and an associated memory. The image processor is configured to implement a face recognition system utilizing the image processing circuitry and the memory, the face recognition system comprising a face recognition module. The face recognition module is configured to identify a region of interest in each of two or more images, to extract a three-dimensional representation of a head from each of the identified regions of interest, to transform the three-dimensional representations of the head into respective two-dimensional grids, to apply temporal smoothing to the two-dimensional grids to obtain a smoothed two-dimensional grid, and to recognize a face based on a comparison of the smoothed two-dimensional grid and one or more face patterns.

### FIELD

The field relates generally to image processing, and more particularly to image processing for recognition of faces.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving face recognition.

In a typical face recognition arrangement, raw image data from an image sensor is usually subject to various preprocessing operations. The preprocessed image data is then subject to additional processing used to recognize faces in the context of particular face recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a face recognition system utilizing the image processing circuitry and the memory, the face recognition system comprising a face recognition module. The face recognition module is configured to identify a region of interest in each of two or more images, to extract a three-dimensional representation of a head from each of the identified regions of interest, to transform the three-dimensional representations of the head into respective two-dimensional grids, to apply temporal smoothing to the two-dimensional grids to obtain a smoothed two-dimensional grid, and to recognize a face based on a comparison of the smoothed two-dimensional grid and one or more face patterns.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a face recognition module in an illustrative embodiment.

FIG. 2 is a flow diagram of an exemplary face recognition process performed by the face recognition module in the image processor of FIG. 1.

FIG. 3 illustrates noisy images of a face.

FIG. 4 illustrates extraction of a head from a body region of interest.

FIG. 5 illustrates application of a rigid transform to a head image.

FIG. 6 illustrates a 2-meridian coordinate system.

FIG. 7 illustrates 2D face grids.

FIG. 8 illustrates selection of a region of interest from 2D grids.

FIG. 9 illustrates examples of ellipses adjustment.

FIG. 10 illustrates a user performing face and hand pose recognition.

FIG. 11 is a flow diagram of an exemplary face training process performed by the face recognition module in the image processor of FIG. 1.

### DETAILED DESCRIPTION

Embodiments of the invention will be illustrated herein in conjunction with exemplary image processing systems that include image processors or other types of processing devices configured to perform face recognition. It should be understood, however, that embodiments of the invention are more generally applicable to any image processing system or associated device or technique that involves recognizing faces in one or more images.

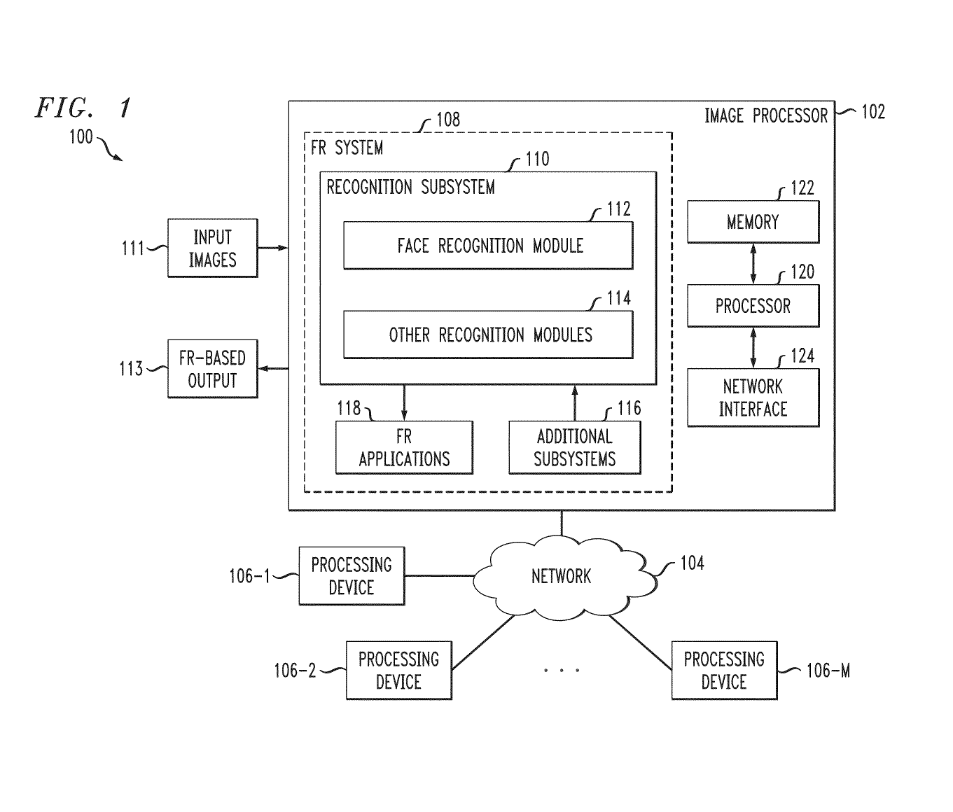

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 110 within a face recognition (FR) system 108. The FR system 108 in this embodiment processes input images 111 from one or more image sources and provides corresponding FR-based output 113. The FR-based output 113 may be supplied to one or more of the processing devices 106 or to other system components not specifically illustrated in this diagram.

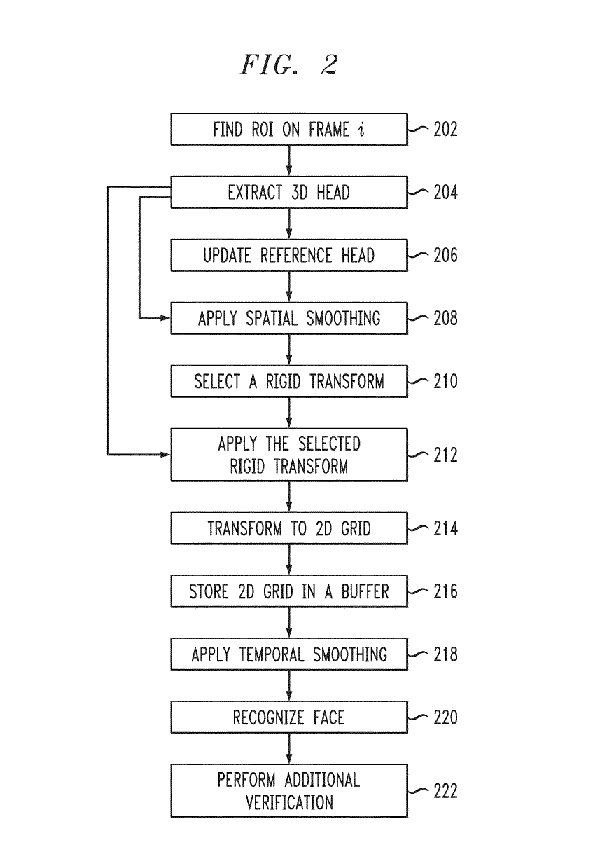

The recognition subsystem 110 of FR system 108 more particularly comprises a face recognition module 112 and one or more other recognition modules 114. The other recognition modules 114 may comprise, for example, respective recognition modules configured to recognize hand gestures or poses, cursor gestures and dynamic gestures. The operation of illustrative embodiments of the FR system 108 of image processor 102 will be described in greater detail below in conjunction with FIGS. 2 through 11.

The recognition subsystem 110 receives inputs from additional subsystems 116, which may comprise one or more image processing subsystems configured to implement functional blocks associated with face recognition in the FR system 108, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the FR system 108 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the FR system 108 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 110 generates FR events for consumption by one or more of a set of FR applications 118. For example, the FR events may comprise information indicative of recognition of one or more particular faces within one or more frames of the input images 111, such that a given FR application in the set of FR applications 118 can translate that information into a particular command or set of commands to be executed by that application. Accordingly, the recognition subsystem 110 recognizes within the image a face from one or more face patterns and generates a corresponding face pattern identifier (ID) and possibly additional related parameters for delivery to one or more of the FR applications 118. The configuration of such information is adapted in accordance with the specific needs of the application.

Additionally or alternatively, the FR system 108 may provide FR events or other information, possibly generated by one or more of the FR applications 118, as FR-based output 113. Such output may be provided to one or more of the processing devices 106. In other embodiments, at least a portion of set of FR applications 118 is implemented at least in part on one or more of the processing devices 106.

Portions of the FR system 108 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of faces within frames of an input image stream comprising the input images 111. Such processing layers may also be implemented in the form of respective subsystems of the FR system 108.

It should be noted, however, that embodiments of the invention are not limited to recognition of faces, but can instead be adapted for use in a wide variety of other machine vision applications involving face or more generally gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the FR applications 118 may be implemented on a different processing device than the subsystems 110 and 116, such as one of the processing devices 106.

Moreover, it is to be appreciated that the image processor 102 may itself comprise multiple distinct processing devices, such that different portions of the FR system 108 are implemented using two or more processing devices. The term “image processor” as used herein is intended to be broadly construed so as to encompass these and other arrangements.

The FR system 108 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the FR system 108 from the depth sensor may include a stream of frames comprising respective depth images, with each such depth image comprising a plurality of depth image pixels. For example, a given depth image D may be provided to the FR system 108 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of FR-based output 113 to one or more image destinations. At least a subset of such image sources and image destinations may be implemented at least in part utilizing one or more of the processing devices 106.

Accordingly, at least a subset of the input images 111 may be provided to the image processor 102 over network 104 for processing from one or more of the processing devices 106.

Similarly, processed images or other related FR-based output 113 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize faces, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 112, 114, 116 and 118 of image processor 102. One possible example of image processing circuitry that may be used in one or more embodiments of the invention is an otherwise conventional graphics processor suitably reconfigured to perform functionality associated with one or more of the components 112, 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of FR-based output 113 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 110 and 116 and the FR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of system that processes image streams in order to recognize faces or gestures. The disclosed techniques can be similarly adapted for use in a wide variety of other systems requiring face recognition or a gesture-based human-machine interface, and can also be applied to other applications, such as machine vision systems in robotics and other industrial applications that utilize face and/or gesture recognition.

The operation of the FR system 108 of image processor 102 will now be described in greater detail with reference to the diagrams of FIGS. 2 through 11.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

FIG. 2 shows a process for face recognition which may be implemented using the face recognition module 112. The FIG. 2 process is assumed to be performed using preprocessed image frames received from a preprocessing subsystem in the set of additional subsystems 116. The preprocessed image frames may be stored in a buffer, which may be part of memory 122. In some embodiments, the preprocessing subsystem performs noise reduction and background estimation and removal, using techniques such as those identified above. The image frames are received by the preprocessing system as raw image data from an image sensor of a depth imager such as a ToF camera or other type of ToF imager. The image sensor in this embodiment is assumed to comprise a variable frame rate image sensor, such as a ToF image sensor configured to operate at a variable frame rate. Accordingly, in the present embodiment, the face recognition module 112 can operate at a lower or more generally a different frame rate than other recognition modules 114, such as recognition modules configured to recognize hand gestures. Other types of image sources supporting variable or fixed frame rates can be used in other embodiments.

The FIG. 2 process begins with block 202, finding a head region of interest (ROI). Block 202 in some embodiments involves defining a ROI mask for a head in an image. The ROI mask is implemented as a binary mask in the form of an image, also referred to herein as a “head image,” in which pixels within the ROI have a certain binary value, illustratively a logic 1 value, and pixels outside the ROI have the complementary value, illustratively a logic 0 value. The head ROI corresponds to a head within the input image.

As noted above, the input image in which the head ROI is identified in block 202 is assumed to be supplied by a ToF imager. Such a ToF imager typically comprises a light emitting diode (LED) light source that illuminates an imaged scene. Distance is measured based on the time difference between the emission of light onto the scene from the LED source and the receipt at the image sensor of corresponding light reflected back from objects in the scene. Using the speed of light, one can calculate the distance to a given point on an imaged object for a particular pixel as a function of the time difference between emitting the incident light and receiving the reflected light. More particularly, distance d to the given point can be computed as follows:

$$d = \frac{Tc}{2}$$

where T is the time difference between emitting the incident light and receiving the reflected light, c is the speed of light, and the constant factor 2 is due to the fact that the light passes through the distance twice, as incident light from the light source to the object and as reflected light from the object back to the image sensor. This distance is more generally referred to herein as a depth value.

The time difference between emitting and receiving light may be measured, for example, by using a periodic light signal, such as a sinusoidal light signal or a triangle wave light signal, and measuring the phase shift between the emitted periodic light signal and the reflected periodic signal received back at the image sensor.

Assuming the use of a sinusoidal light signal, the ToF imager can be configured, for example, to calculate a correlation function c(τ) between input reflected signal s(t) and output emitted signal g(t) shifted by predefined value τ, in accordance with the following equation:

$$c ( τ ) = {lim}_{T \to ∞} \frac{1}{T} {\int }_{T / 2}^{- T / 2} s ( t ) g ( t + τ ) d t .$$

In such an embodiment, the ToF imager is more particularly configured to utilize multiple phase images, corresponding to respective predefined phase shifts τₙ given by nτ/2, where n=0, . . . , 3. Accordingly, in order to compute depth and amplitude values for a given image pixel, the ToF imager obtains four correlation values (A₀, . . . , A₃), where Aₙ=c(τₙ), and uses the following equations to calculate phase shift φ and amplitude a:

$$ϕ = arctan ( \frac{{A}_{3} - {A}_{1}}{{A}_{0} - {A}_{2}} ) , \\ a = \frac{1}{2} \sqrt{{( {A}_{3} - {A}_{1} )}^{2} + {( {A}_{0} - {A}_{2} )}^{2}} .$$

The phase images in this embodiment comprise respective sets of A₀, A₁, A₂ and A₃ correlation values computed for a set of image pixels. Using the phase shift φ, a depth value d can be calculated for a given image pixel as follows:

$$d = \frac{c}{4 πω} ϕ$$

where ω is the frequency of emitted signal and c is the speed of light. These computations are repeated to generate depth and amplitude values for other image pixels. The resulting raw image data is transferred from the image sensor to internal memory of the image processor 102 for preprocessing in the manner previously described.

The head ROI can be identified in the preprocessed image using any of a variety of techniques. For example, it is possible to utilize the techniques disclosed in Russian Patent Application No. 2013135506 to determine the head ROI. Accordingly, block 202 may be implemented in a preprocessing block of the FR system 108 rather than in the face recognition module 112.

As another example, the head ROI may also be determined using threshold logic applied to depth values of an image. In some embodiments, the head ROI is determined using threshold logic applied to depth and amplitude values of the image. This can be more particularly implemented as follows:

1. If the amplitude values are known for respective pixels of the image, one can select only those pixels with amplitude values greater than some predefined threshold. This approach is applicable not only for images from ToF imagers, but also for images from other types of imagers, such as infrared imagers with active lighting. For both ToF imagers and infrared imagers with active lighting, the closer an object is to the imager, the higher the amplitude values of the corresponding image pixels, not taking into account reflecting materials. Accordingly, selecting only pixels with relatively high amplitude values allows one to preserve close objects from an imaged scene and to eliminate far objects from the imaged scene. It should be noted that for ToF imagers, pixels with lower amplitude values tend to have higher error in their corresponding depth values, and so removing pixels with low amplitude values additionally protects one from using incorrect depth information.

2. If the depth values are known for respective pixels of the image, one can select only those pixels with depth values falling between predefined minimum and maximum threshold depths dₘᵢₙ and dₘₐₓ. These thresholds are set to appropriate distances between which the head is expected to be located within the image.

3. Opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

The output of the above-described ROI determination process is a binary ROI mask for the head in the image. It can be in the form of an image having the same size as the input image, or a sub-image containing only those pixels that are part of the ROI. For further description below, it is assumed that the ROI mask is an image having the same size as the input image. As mentioned previously, the ROI mask is also referred to herein as a “head image” and the ROI itself within the ROI mask is referred to as a “head ROI.” Also, for further description below i denotes a current frame in a series of frames.

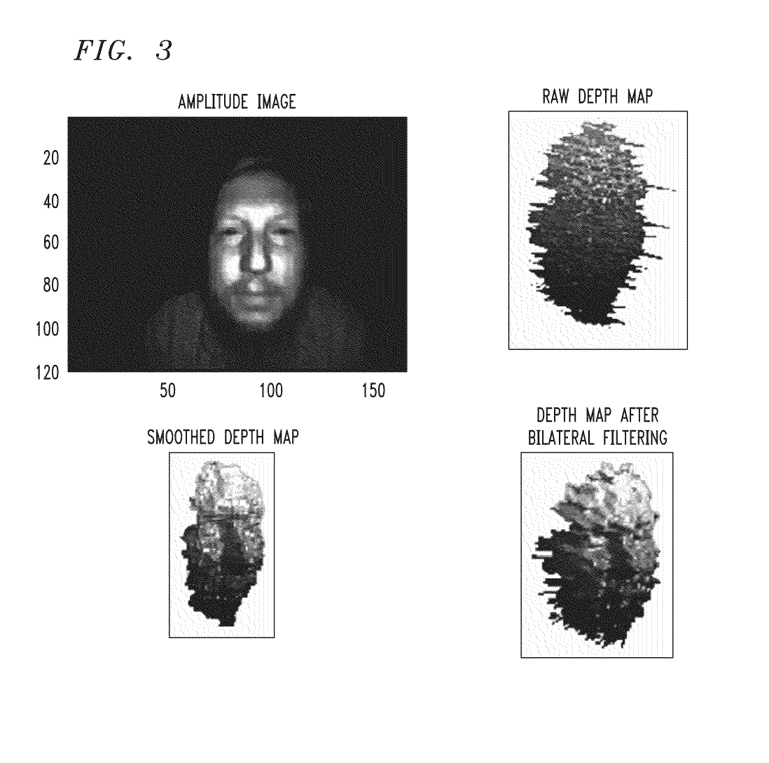

FIG. 3 illustrates noisy images of a face. FIG. 3 shows an example of a source image, along with a raw depth map, smoothed depth map and a depth map after bilateral filtering. In the FIG. 3 example, the source image is an amplitude image, with axes representing indexes of pixels. The raw depth map shown in FIG. 3 is an example of a head ROI mask which may be extracted in block 202. FIG. 3 also shows examples of a smoothed depth map and a depth map after bilateral filtering. These represent two examples of spatial smoothing, which will be described in further detail below with respect to block 208 of the FIG. 2 process.

The FIG. 2 process continues with block 204, extracting 3D head points from the head ROI. Although processing in block 202 results in a depth map corresponding to the head ROI, further processing may be required to separate the head in the head ROI from other parts of the body. By way of example, block 204 may involve separating 3D head points from points corresponding to shoulders or a neck.

In some embodiments, block 204 utilizes physical or real point coordinates to extract 3D head points from the head ROI. If a camera or other image source does not provide physical point coordinates, the points in the head ROI can be mapped into a 3D point cloud with coordinates in some metric units such as meters (m) or centimeters (cm). For clarity of illustration below, it is assumed that the depth map has real metric 3D coordinates for points in the map.

Some embodiments utilize typical head heights for extracting 3D head points in block 204. For example, assume a 3D Cartesian coordinate system having an origin O, a horizontal X axis, a vertical Y axis and a depth axis Z. OX represents from left to right, OY represents from up to down, and OZ is the depth dimension from the camera to the object. Given a minimum value ytop corresponding to a top of the head, block 204 in some embodiments extracts points with coordinates (x, y, z) from the head ROI that satisfy the condition y−ytop<head_height, where head_height denotes a typical height of a human head, e.g., head_height=25 cm.

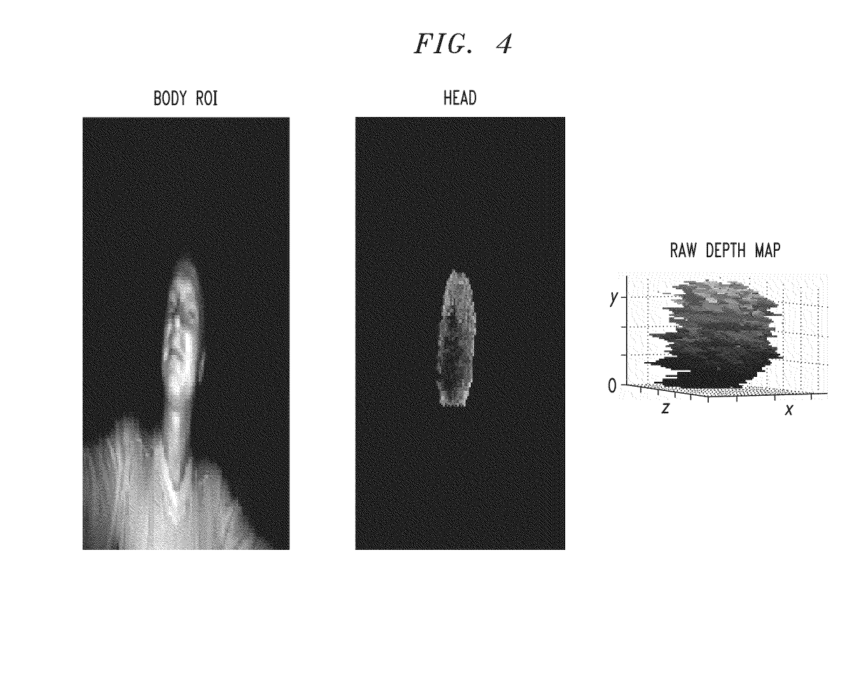

FIG. 4 illustrates an example of extraction of 3D head points from a ROI. FIG. 4 shows a body ROI image, a head extracted from the body ROI image and a raw depth map of the extracted head rendered in a 3D Cartesian coordinate system.

In block 206, a reference head is updated if necessary. As will be further described below with respect to block 216, a buffer of 2D grids is utilized. The buffer length for the 2D grids is denoted buffer_len. If the current frame i is the first frame or if the frame number of i is a multiple of buffer_len, e.g., i=k*buffer_len where k is an integer, then block 206 sets the current head as a new reference head head_{ref}. Block 206 changes a reference head or reference frame every buffer len frames which allows for capturing a change in the pose of the head for subsequent adjustments.

Spatial smoothing is applied to the current frame i and head_{ref} in block 208. Various spatial smoothing techniques may be used. FIG. 3, as discussed above, shows two examples of spatial smoothing. The smoothed depth map in FIG. 3 is obtained by applying a Gaussian 2D smoothing filter on the raw depth map shown in FIG. 3. The depth map after bilateral filtering in FIG. 3 is obtained by applying bilateral filtering to the raw depth map shown in FIG. 3. Spatial smoothing may be performed at least in part by a camera driver. Various other types of spatial smoothing may be performed in other embodiments, including spatial smoothing using filters in place of or in addition to one or both of a Gaussian 2D smoothing filter and a bilateral filter. Block 208 provides a smoothed head for current frame i and head_{ref}.

The FIG. 2 process continues with selecting a rigid transform in block 210. Assuming that the human head is a rigid object, block 210 selects an appropriate rigid transform to align points from the current frame i and head_{ref}. Embodiments may use various types of rigid transforms, including by way of example an iterative closest point (ICP) method or a method using a transform of normal distributions. Similarly, embodiments may use various metrics for selecting a rigid transform. Current frame i and head_{ref} may have different numbers of points without any established correspondence between them. In some embodiments, block 210 may establish a correspondence between points in current frame i and head_{ref} and use a least mean squares method for selecting the rigid transform to be applied.

In some embodiments, a rigid transform is applied to translate the respective heads in current frame i and head_{ref} so that their respective centers of mass coincide or align with one another. Let C₁ₛₘ and C₂ₛₘ be the 3D point clouds representing the smoothed reference head and the smoothed head from the current frame, respectively. C₁ₛₘ={p₁ₛₘ, . . . , p_{Nsm}} and C₂ₛₘ{q₁ₛₘ, . . . , q_{Msm}} where pₛₘ and qₛₘ denote points in the respective 3D clouds, Nsm denotes the number of points in C₁ₛₘ and Msm denotes the number of points in C₂ₛₘ. The centers of mass cm₁ₛₘ and cm₂ₛₘ of the respective 3D point clouds C₁ₛₘ and C₂ₛₘ may be determined by taking an average of the points in the cloud according to

$${cm}_{1 sm} = \frac{1}{Nsm} {\sum }_{i = 1}^{Nsm} {p}_{ism} , and$$

$${cm}_{2 sm} = \frac{1}{Msm} {\sum }_{j = 1}^{Msm} {q}_{jsm} .$$

The origins of the respective 3D spaces are translated to align with the respective centers of mass by adjusting points in the respective 3D spaces according to

pᵢₛₘ→pᵢₛₘ−cm₁ₛₘ, and

qⱼₛₘ→qⱼₛₘ−cm₂ₛₘ.

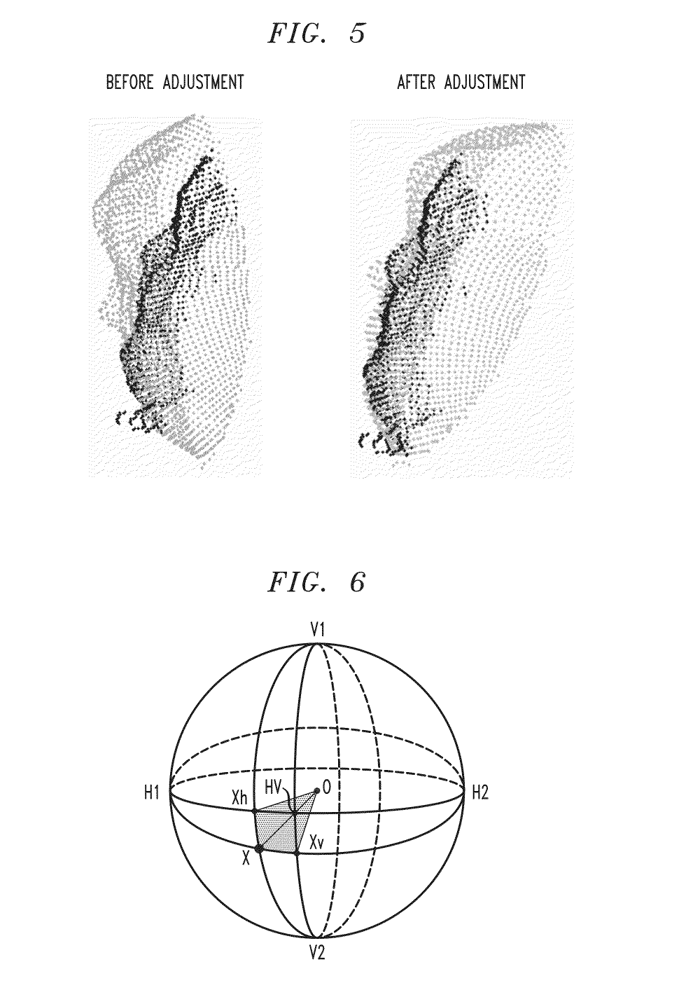

Next, a rigid transform F between C₁ₛₘ and C₂ₛₘ is selected. FIG. 5 shows an example of adjusting 3D point clouds to select rigid transform F. FIG. 5 shows two 3D point clouds which have been spatially smoothed, one shaded gray and the other shaded black, before and after adjustment using rigid transform F using ICP. In FIG. 5, the initial 3D point clouds are already translated so that their respective centers of mass are aligned. The rigid transform F is selected to align the gray 3D point cloud with the black 3D point cloud as shown in FIG. 5.

In block 212, the rigid transform selected in block 210 is applied to the non-smoothed head extracted in step 204. Let C_{old} be the 3D point cloud representing the non-smoothed head for the current frame i extracted in step 204, where C_{old}={p_{1old}, . . . , p_{Nold}}. Applying the transform F selected in block 210 results in a new point cloud C={p₁, . . . , p_{N}}. FIG. 2 shows that the rigid transform selected in block 210 is applied to the non-smoothed version of the current frame i in block 212. In some embodiments, this avoids double smoothing resulting from applying spatial smoothing in block 208 and temporal smoothing in block 218, which will be discussed in further detail below. In some cases, such double smoothing results in one or more significant points of the current frame i being smoothed out. In other cases, however, such double smoothing may not be a concern and block 212 may apply the selected rigid transform to the spatially smoothed version of the current frame i.

The FIG. 2 process continues with transforming the 3D head into a 2D grid in block 214. 3D representations of a head in the Cartesian coordinate system may be highly variant to soft motion on the horizontal and/or vertical axis. Thus, the coordinate system is changed from a 3D Cartesian coordinate system to a 2D grid in block 214. In some embodiments, the 2D grid utilizes a spherical or 1-meridian coordinate system. The spherical coordinate system is invariant to soft motions along the horizontal axis relative to the Cartesian coordinate system. In other embodiments, the 2D grid utilizes a 2-meridian coordinate system. The 2-meridian coordinate system is invariant to such soft motion in both the horizontal and vertical axes relative to the Cartesian coordinate system. Using the 2-meridian coordinate system, the transform changes from Cartesian coordinates (x, y, z)→r(θ, φ).

FIG. 6 illustrates an example of a 2-meridian coordinate system used in some embodiments. The 2-meridian coordinate system is defined by two horizontal poles denoted H1 and H2 in FIG. 6, two vertical poles denoted V1 and V2 in FIG. 6, and an origin point on a sphere denoted O in FIG. 6. In FIG. 6, H1HVH2 and V1HVV2 denote two perpendicular circumferential planes having O as the center. H1HVH2 denotes the first prime meridian in the 2-meridian coordinate system shown in FIG. 6 and V1HVV2 denotes the second prime meridian in the 2-meridian coordinate system shown in FIG. 6. Let X be a given point on the sphere shown in FIG. 6 such that circumference V1XV2 intersects the first prime meridian at point Xh and circumference H1XH2 intersects the second prime meridian at point Xv.

Block 214 constructs a 2D grid for a point cloud C as a matrix G(θ, φ) according to

$$r = \sqrt{{x}_{2} + {y}^{2} + {z}^{2}}$$

$$θ = arctan ( \frac{y}{z} )$$

$$ϕ = arctan ( \frac{x}{z} )$$

In FIG. 6, the angles of θ and φ are denoted ∠XOXh and ∠XOXv, respectively. In the 2-meridian coordinate system,

r>0,

0≦θ≦2π, and

0≦φ≦2π.

The angles θ and φ may be represented in degrees rather than radians. In such cases,

0°≦θ≦360°, and

0°≦φ≦360°.

To construct a grid of m rows and n columns, a subspace S_{i,j} is defined, where 1≦i≦m and 1≦j≦n. The subspace is limited by

$$\frac{2 ( i - 1 ) π}{m} \leq θ \leq \frac{2 i π}{m} , and$$

$$\frac{2 ( j - 1 ) π}{n} \leq ϕ \leq \frac{2 j π}{n} .$$

C_{i,j}={p′₁, . . . , p′ₖ} denotes the subset of points from C within subspace S_{i,j}. Thus, entries g_{i,k} in G are determined according to

$${g}_{i , j} = \frac{1}{k} {\sum }_{i = 1}^{k} {r}_{i}^{′}$$

where r′ᵢ is the distance of point p′ᵢ from the origin. If there is no point in the subset C_{i,j} of points from C within the subspace S_{i,j} for a specific pair (i,j), then g_{i,j} is set to 0.

If intensities of the pixels in the head ROI are available in addition to depth values, a 2D grid of C may be constructed as a matrix GI(θ, φ). Let I_{i,j}={s₁, . . . , sₖ} denote intensity values for points {p′₁, . . . , p′ₖ}. Entries gi_{i,j} in GI may then be determined according to

$${gi}_{i , j} = \frac{1}{k} {\sum }_{i = 1}^{k} {s}_{i} .$$

Embodiments may use G, GI or some combination of G and GI as the 2D grid. In some embodiments, the 2D grid is determined according to

$$GG = \frac{{G}_{1} + {GI}_{1}}{2}$$

where G₁ and GI₁ are matrices G and GI scaled to one. Various other methods for combining G and GI may be used in other embodiments. As an example, a 2D grid may be determined by applying different weights to scaled versions of matrices G, GI and/or GG or some combination thereof.

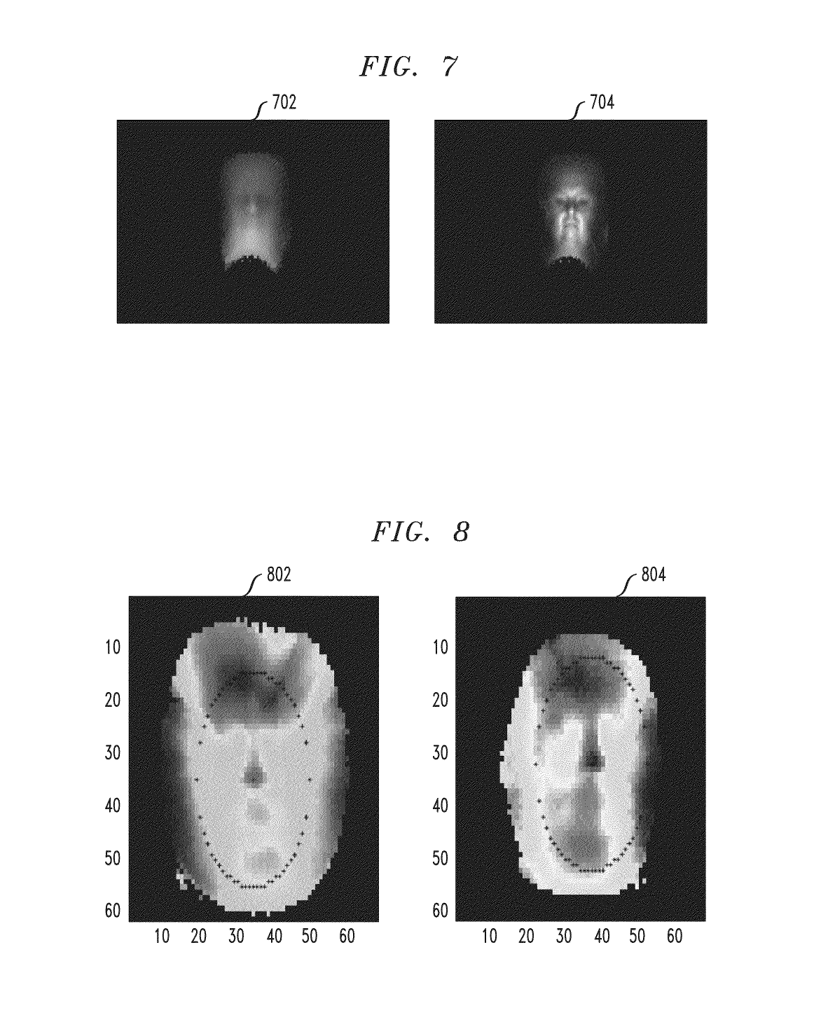

In some embodiments, an intensity image obtained from an infrared laser using active highlighting is available but a depth map is not available or is unreliable. In such cases, reliable depth values may be obtained using amplitude values for subsequent computation of 2D grids such as G, GI or GG. FIG. 7 shows examples of 2D face grids. 2D face grid 702 shows a grid obtained using matrix G and 704 shows a grid obtained using matrix GI. For clarity of illustration below, the 2D grid obtained from the processing block 214 is assumed to be grid G. Embodiments, however, may use GI, GG or some other combination of G, GI and GG in place of G.

After transforming to the 2D grid, block 214 moves to a coordinate system (u, v) on the 2D grid. A function Q(u, v) on the 2D grid is defined for integer points u=i, v=j 1≦i≦m and 1≦j≦n and Q(i,j)=g_{i,j}.

The FIG. 2 process continues with storing the 2D grid in a buffer in block 216. As described above, the buffer has length buffer len. In some embodiments, for a frame rate of 60 frames per second, buffer len is about 50-150. Various other values for buffer len may be used in other embodiments. If the current frame i is the first frame or if the frame number i is a multiple of buffer_len, e.g., i=k*buffer_len where k is an integer, the buffer is cleared and the grid for the current frame i is added to the buffer. If the current frame i is not the first frame or is not a multiple of buffer_len, the grid for the current frame i is added to the buffer without clearing the buffer. Thus, for buffer_len*k≦i≦buffer_len*(k+1) where k is a positive integer, the buffer stores grids gridᵢ₁, . . . , gridᵢ, where i1=buffer_len*k. For 1≦i≦buffer_len , the buffer stores grids grid₁, . . . , gridᵢ.

In block 218, temporal smoothing is applied to the grids stored in the buffer in step 216. After the processing in block 216, the buffer has a set of grids {gridⱼ₁, . . . , gridⱼₖ} where k≦buffer_len. The corresponding matrices G for the grids stored in the buffer are denoted {Gⱼ₁, . . . , Gⱼₖ}. Various types of temporal smoothing may be applied to the grids stored in the buffer. In some embodiments, a form of averaging is applied according to

$${G}_{smooth} = \frac{1}{k} {\sum }_{l = 1}^{k} {G}_{jl} .$$

In other embodiments, exponential smoothing is applied according to

Gₛₘₒₒₜₕ=αGₛₘₒₒₜₕ+(1−α)Gⱼₗ

where α is a smoothing factor and 0<α<1.

The FIG. 2 process continues with block 220, recognizing a face. Although the face recognition in block 220 may be performed at any time, in some embodiments face recognition is performed when smoothing is done on a full or close to full buffer, i.e., when the number of grids in the buffer is equal to or close to buffer_len. Face recognition may be performed by comparing the smoothed 2D grid Gₛₘₒₒₜₕ to one or more face patterns. In some embodiments, the face patterns may correspond to different face poses for a single user. In other embodiments, the face patterns may correspond to different users although two or more of the face patterns may correspond to different face poses for a single user.

The face patterns and Gₛₘₒₒₜₕ may be represented as matrices of values. Recognizing the face in some embodiments involves calculating distance metrics characterizing distances between Gₛₘₒₒₜₕ and respective ones of the face patterns. If the distance between Gₛₘₒₒₜₕ and a given one of the face patterns is less than some defined distance threshold, Gₛₘₒₒₜₕ is considered to match the given face pattern. In some embodiments, if Gₛₘₒₒₜₕ is not within the defined distance threshold of any of the face patterns, Gₛₘₒₒₜₕ is recognized as the face pattern having a smallest distance to Gₛₘₒₒₜₕ. In other embodiments, if Gₛₘₒₒₜₕ is not within the defined distance threshold of any of the face patterns then Gₛₘₒₒₜₕ is rejected as a non-matching face.

In some embodiments, a metric representing a distance between Gₛₘₒₒₜₕ and one or more pattern matrices Pⱼ is estimated, where 1≦j≦w. The pattern matrix having the smallest distance is selected as the matching pattern. Let R(Gₛₘₒₒₜₕ, Pⱼ) denote the distance between grids Gₛₘₒₒₜₕ and Pⱼ. The result of the recognition in block 220 is thus the pattern with the number

$${argmin}_{j = 1 , … , w} R ( {G}_{smooth} , {P}_{j} ) .$$

To find R(Gₛₘₒₒₜₕ, Pⱼ), some embodiments use the following procedure:

1. Find respective points in the 2D grids with a largest depth value, i.e., a point farthest from the origin in the depth dimension near the centers of the grids. Typically, this point will represent the nose of a face.

2. Exclude points outside an inner ellipse. FIG. 8 shows examples of such inner ellipses in images 802 and 804. Images 802 and 804 represent respective smoothed 2D grids, where the black diamond points are the inner ellipse. Excluding points outside the inner ellipse excludes unreliable border points of the visible head. Such border points typically do not contain information relevant for face recognition.

3. Move the inner ellipse in the range of points −n_el:+n_el around the possible nose for vertical and horizontal directions and find point-by-point sum of absolute difference (SAD) measures. n_el is an integer value, e.g., n_el=5, chosen due to the uncertainty in selection of the noise point in step 1.

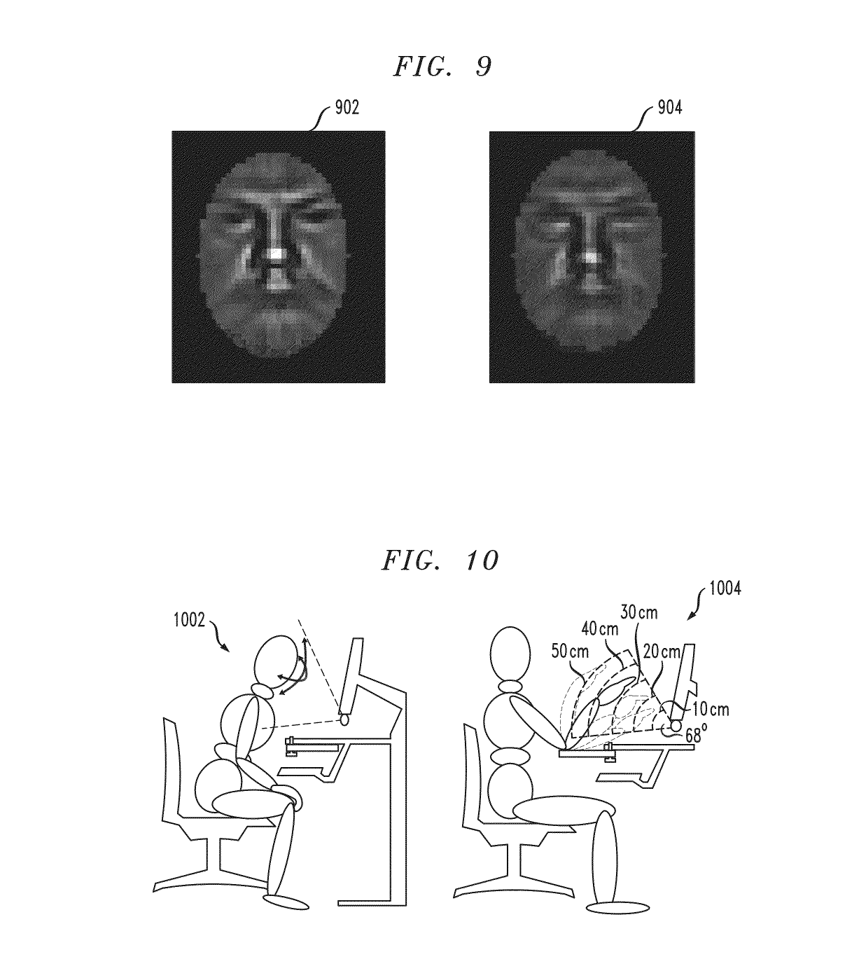

4. The distance R(Gₛₘₒₒₜₕ, Pⱼ) is the minimum SAD for all mutual positions of the ellipses from Gₛₘₒₒₜₕ and Pⱼ. FIG. 9 shows examples of good and bad ellipse adjustments. Image 902 represents a small R where the smoothed 2D grid and a pattern belong to the same person. Image 904 represents a large R where the smoothed 2D grid and a pattern belong to different persons. After computing R(G_{smooth,} Pⱼ) for j=1, . . . , w, the result of the recognition is the argmin through all R(Gₛₘₒₒₜₕ, Pⱼ).

The FIG. 2 process concludes with performing additional verification in block 222. The processing in block 222 is an optional step performed in some embodiments of the invention. In some use cases, a user may be moving around a camera accidentally and thus face recognition may be performed inadvertently. In other use cases, face recognition may recognize the wrong person and additional verification may be used to restart the face recognition process.

Face recognition may be used in a variety of FR applications, including by way of example logging on to an operating system of a computing device, unlocking one or more features of a computing device, authenticating to gain access to a protected resource, etc. Additional verification in block 222 can be used to prevent accidental or inadvertent face recognition for FR applications.

The additional verification in block 222 in some embodiments requires recognition of one or more specified hand poses. Various methods for recognition of static or dynamic hand poses or gestures may be utilized. Exemplary techniques for recognition of static hand poses are described in Russian Patent Application No. 2013148582, filed Oct. 30, 2013 and entitled “Image Processor Comprising Gesture Recognition System with Computationally-Efficient Static Hand Pose Recognition,” which is commonly assigned herewith and incorporated by reference herein.

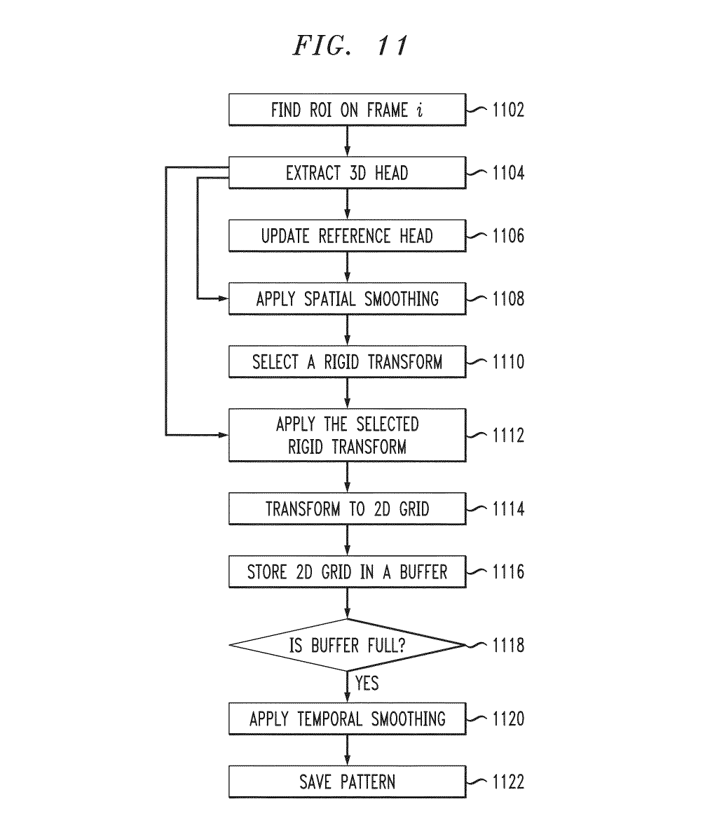

FIG. 10 illustrates portions of a face recognition process which may be performed by FR system 108. To start, a user slowly rates his/her head in front of a camera until the FR system 108 matches input frames to one or more patterns. The FR system 108 then asks the user to confirm that the match is correct by showing one hand posture, denoted POS_YES, or to indicate that the match is incorrect by showing another hand posture, denoted POS_NO. Image 1002 in FIG. 10 shows the user rotating his/her head in front of a camera or other image sensor. Image 1004 in FIG. 10 shows the user performing a hand pose in front of the camera of other image sensor.

If the FR system 108 recognizes hand posture POS_YES, FR-based output 113 is provided to launch one or more of the FR applications 118 or perform some other desired action. If the FR system 108 recognizes hand posture POS_NO, the face recognition process is restarted. In some embodiments, a series of frames of the user's head may closely match multiple patterns. In such cases, when the FR system 108 recognizes hand posture POS_NO the FR system 108 asks the user to confirm whether an alternate pattern match is correct by showing POS_YES or POS_NO again. If the FR system 108 does not recognize hand posture POS_YES or POS_NO, an inadvertent or accidental face recognition may have occurred and the FR system 108 takes no action, shuts down, goes to a sleep mode, etc.

FIG. 11 shows a process for face pattern training Blocks 1102-1116 in FIG. 11 correspond to blocks 202-216 in FIG. 2. In block 1118, a determination is made as to whether the buffer is full, i.e., whether the number of grids in the buffer is equal to buffer_len. In some embodiments, a determination is made as to whether the number of grids in the buffer is equal to or greater than a threshold number of grids other than buffer_len.

If block 1118 determines that the buffer is full, temporal smoothing is applied to the full grid buffer in block 1120 and a face pattern is saved in block 1122. The processing in blocks 1120 and 1122 may be repeated as the buffer is cleared and filled in block 1116. The temporal smoothing in block 1120 corresponds to the temporal smoothing in block 218. Using the FIG. 11 process, different patterns for a single user or patterns for multiple users may be trained and saved for subsequent face recognition. In some embodiments, an expert or experts may choose one or more patterns from those saved in block 1122 as the pattern(s) for a given user.

The particular types and arrangements of processing blocks shown in the embodiments of FIGS. 2 and 11 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved face recognition performance relative to conventional arrangements. 3D face recognition in some embodiments utilizes distance from a camera, shape and other 3D characteristics of an object in addition to or in place of intensity, luminance or other amplitude characteristics of the object for face recognition. Thus, these embodiments may utilize images or frames from a low-cost 3D ToF camera which returns a very noisy depth map and has a small spatial resolution, e.g., about 150×150 points, where 2D feature extraction is difficult or impossible due to the noisy depth map. As described above, in some embodiments a 3D object is transformed into a 2D grid using a 2-meridian coordinate system which is invariant to soft movements of objects within an accuracy of translation in a horizontal or vertical direction. These embodiments allow for improved accuracy of face recognition in conditions involving significant depth noise and small spatial resolution.

Different portions of the FR system 108 can be implemented in software, hardware, firmware or various combinations thereof. For example, software utilizing hardware accelerators may be used for some processing blocks while other blocks are implemented using combinations of hardware and firmware.

At least portions of the FR-based output 113 of FR system 108 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

1. A method comprising steps of:
identifying regions of interest in respective ones of two or more images;
extracting a three-dimensional representation of a head from each of the identified regions of interest;
transforming the three-dimensional representations of the head into respective two-dimensional grids;
applying temporal smoothing to the two-dimensional grids to obtain a smoothed two-dimensional grid; and
recognizing a face based on a comparison of the smoothed two-dimensional grid and one or more face patterns;
wherein the steps are implemented in an image processor comprising a processor coupled to a memory.

2. The method of claim 1 further comprising applying spatial smoothing to the three-dimensional representations of the head using at least one of a bilateral filter and a Gaussian two-dimensional smoothing filter.

3. The method of claim 1 further comprising applying a rigid transform to the three-dimensional representations of the head to align the three-dimensional representations of the head.

4. The method of claim 3 wherein the rigid transform comprises aligning respective centers of mass of the three-dimensional representations of the head.

5. The method of claim 3 wherein the rigid transform utilizes one of an iterative closest point method and a normal distribution transform.

6. The method of claim 1 wherein transforming the three-dimensional representations of the head into respective two-dimensional grids comprises transforming from a Cartesian coordinate system to a spherical coordinate system.

7. The method of claim 1 wherein transforming the three-dimensional representations of the head into respective two-dimensional grids comprises transforming from a Cartesian coordinate system to a 2-meridian coordinate system.

8. The method of claim 7 wherein the 2-meridian coordinate system comprises two horizontal poles, two vertical poles, an origin, a first prime meridian passing through the two horizontal poles having the origin at its center and a second prime meridian passing through the two vertical poles having the origin at its center, where the first prime meridian and the second prime meridian define perpendicular circumferential planes.

9. The method of claim 7 wherein transforming the three-dimensional representations of the head into respective two-dimensional grids comprises calculating
$$θ = arctan ( \frac{y}{z} )$$
$$ϕ = arctan ( \frac{x}{z} )$$
where (θ, φ) are coordinates in the 2-meridian coordinate system, arctan denotes the arctangent function and (x, y, z) are coordinates in the Cartesian coordinate system where z is a depth dimension.

10. The method of claim 9 wherein transforming the three-dimensional representations of the head into respective two-dimensional grids further comprises, for a given two-dimensional grid, calculating a matrix G of m rows and n columns for a space S_{i,j}, 1≦i≦m and 1≦j≦n limited by
$$\frac{2 ( i - 1 ) π}{m} \leq θ \leq \frac{2 i π}{m} and \frac{2 ( j - 1 ) π}{n} \leq ϕ \leq \frac{2 j π}{n} ,$$
where entries g_{i,j} in G are determined according to
$${g}_{i , j} = \frac{1}{k} {\sum }_{i = 1}^{k} {r}_{i}^{′}$$
where r′ᵢ is the distance of point p′ᵢ from the origin calculated using r=√ x̅²̅+̅y̅²̅+̅z̅²̅ for a subset of points C_{i,j}={p′₁, . . . , p′ₖ}.

11. The method of claim 10 wherein transforming the three-dimensional representations of the head into respective two-dimensional grids further comprises, for the given two-dimensional grid, calculating a matrix GI, where entries gi_{i,j} in GI are determined according to
$${gi}_{i , j} = \frac{1}{k} {\sum }_{i = 1}^{k} {s}_{i}$$
where I_{i,j}={s₁, . . . , sₖ} denotes intensity values of the points {p′₁, . . . , p′ₖ } and the given two-dimensional grid comprises a combination of matrices G and GI.

12. The method of claim 1 wherein applying temporal smoothing to the two-dimensional grids to obtain the smoothed two-dimensional grid comprises applying exponential smoothing.

13. The method of claim 1 wherein the smoothed two-dimensional grid and face patterns comprise respective matrices of values, and recognizing the face comprises:
calculating distance metrics between the smoothed two-dimensional grid and respective ones of the face patterns; and
recognizing the face based on the distance metrics.

14. The method of claim 13 wherein calculating the respective distance metrics is based on a set of points within an ellipse centered on a nose of the smoothed two-dimensional grid.

15. The method of claim 13 wherein the distance metrics comprise respective sums of absolute difference for corresponding positions in the smoothed two-dimensional grid and respective ones of the face patterns.

16. (canceled)

17. A method comprising steps of:
identifying regions of interest in respective ones of two or more images;
extracting a three-dimensional representation of a head from each of the identified regions of interest;
transforming the three-dimensional representations of the head into respective two-dimensional grids;
applying temporal smoothing to the two-dimensional grids to obtain a smoothed two-dimensional grid; and
storing the smoothed two-dimensional grid as a face pattern for a given user;
wherein the steps are implemented in an image processor comprising a processor coupled to a memory.

18. An apparatus comprising:
an image processor comprising image processing circuitry and an associated memory;
wherein the image processor is configured to implement a face recognition system utilizing the image processing circuitry and the memory, the face recognition system comprising a face recognition module; and
wherein the face recognition module is configured:
to identify a region of interest in each of two or more images;
to extract a three-dimensional representation of a head from each of the identified regions of interest;
to transform the three-dimensional representations of the head into respective two-dimensional grids;
to apply temporal smoothing to the two-dimensional grids to obtain a smoothed two-dimensional grid; and
to recognize a face based on a comparison of the smoothed two-dimensional grid and one or more face patterns.

19. (canceled)

20. (canceled)

21. The method of claim 17 further comprising applying spatial smoothing to the three-dimensional representations of the head using at least one of a bilateral filter and a Gaussian two-dimensional smoothing filter.

22. The method of claim 17 further comprising applying a rigid transform to the three-dimensional representations of the head to align the three-dimensional representations of the head.

23. The method of claim 22 wherein the rigid transform comprises aligning respective centers of mass of the three-dimensional representations of the head.
